(19) United States
(12) Patent Application Publication
(10) Pub. No.: US 2011/0153387 A1
(43) Pub. Date: Jun. 23, 2011

(54) CUSTOMIZING SURVEYS

(75) Inventor: Sheng Ma, Yonkers, NY (US)

(73) Assignee: Google Inc., Mountain View, CA (US)

(21) Appl. No.: 12/640,276

(22) Filed: Dec. 17, 2009

(51) Int. Cl. G06Q 10/00; G06Q 30/00

(52) U.S. Cl. 705/7.32; 705/347; 705/14.44; 705/14.43

(57) ABSTRACT

Surveys are customized for respondents based on historical information of the respondents' system usage activity by generating customized survey questions based on the historical information and/or by analyzing responses to survey questions based on the historical information. The results of survey response analysis and/or aggregation can be used to create, modify, and/or validate one or more system settings.

### TECHNICAL FIELD

This disclosure relates to customizing surveys.

### BACKGROUND

Surveys are frequently used to obtain information from respondents regarding various topics. For example, surveys have historically been used to gather information regarding respondents' interests, motivations, perceptions, preferences, habits, or the like. Surveys have been delivered in many forms, including by oral and written questions selected from a group of generic questions. Responses to the survey questions can be analyzed and used to obtain statistical information about a group of respondents, and this statistical information may be extrapolated to a larger population.

### SUMMARY

In one general aspect, a computer-implemented method for conducting a survey includes receiving, by one or more processors of a survey computer system, historical information relating to activity involving a user of an affiliated system, providing a survey to the user in response to a selected action involving the user within the affiliated system, receiving, by one or more processors of the survey computer system, survey information in response to the survey; and customizing, by one or more processors of the survey computer system, the survey for the user based on the historical information.

Implementations may include one or more of the following features. For example, customizing the survey includes creating a question of the survey based on the historical information. Customizing the survey includes adjusting an analysis of the survey information based on the historical information. The historical information includes information regarding at least one advertisement delivered to the user. Customizing the survey includes creating a question regarding the user's perception of a causal contribution of the at least one advertisement to the selected action involving the user. The survey information can be analyzed, and, based at least in part on analyzing the survey information, an attribution model for determining an apportionment of causal contribution among advertisements that were delivered to the user prior to the selected action can be created, modified, and/or validated.

In another general aspect, a system for conducting a survey includes a receiver that receives historical information relating to activity involving a user of an affiliated system and that receives survey information from the user, the survey information being based on a survey provided to the user in response to a selected action involving the user within the affiliated system. A transmitter provides the survey to the user in response to the selected action involving the user within the affiliated system. At least one processor is programmed to customize the survey in response to the selected action involving the user within the affiliated system. At least one processor customizes the survey based, at least in part, on the historical information.

Implementations may include one or more of the following features. For example, the processor is programmed to customize the survey by creating a survey question based on the historical information. The processor is programmed to customize the survey by adjusting an analysis of the survey information based on the historical information. The historical information includes information regarding at least one advertisement delivered to the user. The processor is programmed to customize the survey by creating a question regarding the user's perception of a causal contribution of the at least one advertisement delivered to the user to the selected action involving the user. The processor is programmed to perform at least one of aggregating and analyzing the survey information, and, to perform at least one of creating, modifying, and validating an attribution model based on at least one of the aggregation and the analysis. The he attribution model is for determining an apportionment of causal contribution to the at least one advertisement that was delivered to the user prior to the selected action.

In another general aspect, a computer-implemented method for advertising includes receiving, by at least one processor of an attribution computer system, survey information relating to at least one customized survey of a user, the survey information including information based on historical information regarding activity of an affiliated system that involves the user. At least one processor of the attribution computer system performs at least one of creating, modifying, and validating an attribution model, the attribution model for determining an apportionment of causal contribution to the at least one advertisement that was delivered to the user prior to a selected action, and apportioning attribution credit to the at least one advertisement based on the attribution model.

Implementations may include one or more of the following features. For example, at least one processor of the attribution computer system performs at least one of creating and modifying the attribution model based on an aggregation of survey information related to customized surveys of users, each customized survey being based on historical information regarding activity of the affiliated system that involves an associated user of the affiliated system. At least one processor of the attribution computer system performs at least one of creating and modifying the attribution model based on survey information associated only with the user, and the method further includes associating the attribution model only with the user as a user-specific attribution model. At least one processor of the attribution computer system performs at least one of creating and modifying the attribution model based on survey information associated only with one or more users of a predetermined group of users of the affiliated system, and the method further comprises associating the attribution model only with the users of the predetermined group.

In another general aspect, a computer-implemented method for advertising includes receiving, by one or more processors of an advertisement distribution computer system, survey information relating to at least one customized survey of a user, the survey information including information based on historical information regarding activity involving the user on an affiliated system, performing, by one or more processors of the advertisement distribution computer system, at least one of creating, modifying, and validating a distribution setting, the distribution setting determining, at least in part, how the advertisement distribution computer system selects advertisements for distribution, and distributing advertisements based on selections made by the advertisement distribution computer system according to the distribution setting.

Implementations may include one or more of the following features. For example, the distribution setting relates to a group membership of the user, and distributing includes determining that the user belongs to the group, and selecting an advertisement associated with the group. The distribution setting relates to targeting information associated with the user, and wherein distributing includes comparing the targeting information associated with the user with targeting information associated with candidate advertisements, and an advertisement is selected based on the comparison.

In another general aspect, a computer-implemented method of advertising includes receiving, by one or more processors of an advertisement campaign management computer system, survey information relating to at least one customized survey of a user, the survey information including information based on historical information regarding activity involving the user on an affiliated system, performing, by one or more processors of the advertisement campaign management computer system, at least one of creating, modifying, and validating a campaign setting, the campaign setting being for determining, at least in part, how an advertisement associated with the campaign is delivered, and distributing advertisements according to the campaign setting.

The details of one or more implementations are set forth in the accompanying drawings and the description below. Other features will be apparent from the description and drawings, and from the claims.

### DESCRIPTION OF DRAWINGS

FIG. 1 is an illustration of a system for making and using customized surveys for online advertisements.

FIGS. 2A and 2B are flow charts illustrating processes for customizing surveys.

FIG. 3 is a diagram illustrating a computer system operable in the system of FIG. 1.

FIGS. 4 and 5 are block diagrams illustrating processes for making and using customized surveys in the system of FIG. 1.

Like reference symbols in the various drawings indicate like elements.

### DETAILED DESCRIPTION

In many contexts, various participants or users of a multi-party system, such as a commercial system, a political system, or an educational system, among other systems, may wish to obtain information from other participants or users of the system. Particularly, users of a system may wish to obtain information from other users regarding subjects relating to their individual or collective use of the system. For example, many political candidates and/or those associated with political campaigns way wish to learn how various positions, ideas, proposals, or strategies are perceived by potential voters, including how the candidates could modify and/or improve the perception of potential voters. Similarly, the potential voters' reactions to opposing candidates' messages or actions may be of interest to the candidate or campaign staff. Likewise, in a commercial system, providers of goods and/or services, or other participants who provide information to other users the system, may wish to learn how advertisements, promotions, or other information are received by customers and/or potential customers, partners, or other participants.

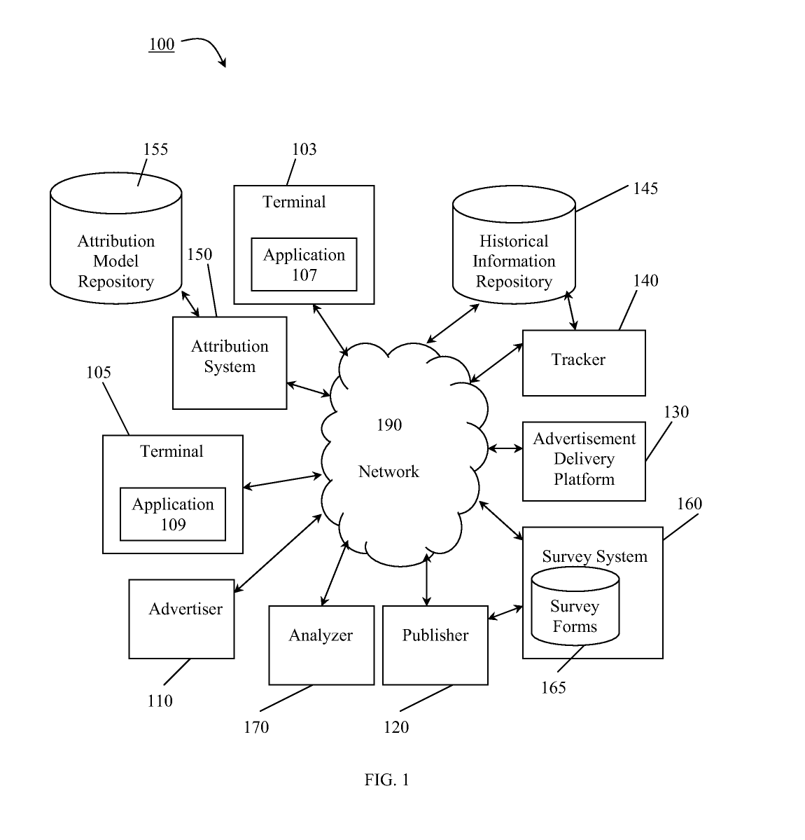

Referring to FIG. 1, a system 100 can be used, for example, for commercial activities. The system 100 includes consumer terminals 103 and 105 that are used by potential customers to browse, research, compare, and/or purchase goods and/or services from one or more sellers, such as advertiser 110. The advertiser 110 provides, in addition to selected goods and/or services, advertisements or other promotional information for such goods and/or services. For example, the advertiser 110 can provide one or more display advertisements, email advertisements, paid search advertisements, coupons, and/or other information over a network 190, such as the Internet. In some implementations, the advertiser can distribute advertisements to web pages or other locations, which are accessible by the consumer terminals 103 and 105 using applications 107 and 109, such as web browsing applications. The advertisements can be distributed to the potential customers as they browse content. A publisher 120 that controls one or more such web pages or other locations may sell advertisement space to the advertiser 110 directly, such as through a direct sales force, through an advertisement delivery platform 130, or through a combination thereof. Thus, when a potential customer visits a web page or other location controlled by the publisher 120 using the consumer terminal 103, an advertisement provided by the advertiser 110 can be displayed to the potential customer on the consumer terminal 103.

The advertisement delivery platform 130, such as the ADWORDS system or the ADSENSE system, each operated by Google Inc., or another advertisement delivery system, is configured to select an advertisement for delivery to a particular potential customer based on any number of factors, such as one or more of demographic information, historical advertisement selection information, advertisement performance information, and targeting criteria provided by the advertiser 110, among other factors. As such, the advertisement delivery platform 130 can be operable with a tracker 140 that is operable to receive and store information regarding activity involving the consumer terminals 103 and 105. For example, cookies and/or agent programs can be used to gather and transmit historical usage information regarding activity involving the consumer terminals 103 and 105 to the tracker 140. The historical usage information is stored in a historical information repository 145 and can include, for example, location information regarding locations visited by potential customers, information regarding advertisements delivered to the potential customers at those locations, information regarding interactions with the delivered advertisements, or other historical information. The tracker 140 and/or the advertisement delivery platform 130 can acquire or create the historical information and/or information regarding the potential customers in an anonymous form, or take other precautions to avoid unauthorized or undesired dissemination of sensitive personal information of the potential customers. Additionally, potential consumers may be assigned a profile for use in selecting advertisements.

The advertisement delivery platform 130 is also operable with an attribution system 150 that is configured to assign attribution credit between or among advertisements which were delivered to a potential customer before a sale, or other action, such as an account creation. The attribution credit represents to the advertiser 110, the publisher 120, and/or the advertisement delivery platform 130 a causal link between the delivery of the advertisement and the subsequent action involving the potential customer. Accordingly, the attribution credit can be used, for example, to distribute or apportion revenue associated with the subsequent action between or among the publishers associated with the delivery of the advertisements to the potential customer. In one example, a referral fee or other payment made by the advertiser 110 based on a sale or other completed action can be divided among and distributed to two or more publishers based on attribution credit assigned to each publisher. The attribution system 150 can be configured to assign attribution credit based on one or more customizable attribution model(s) stored in the attribution model repository 155. The attribution models are configured such that the attribution system 150 assigns attribution credit based on historical information, such as historical information regarding a potential customer involved in a selected action, and one or more factors, such as an amount of time between delivery of an advertisement and completion of the selected action, a type of advertisement that was delivered to the potential customer, and/or an indication that the potential customer interacted with the advertisement, among others.

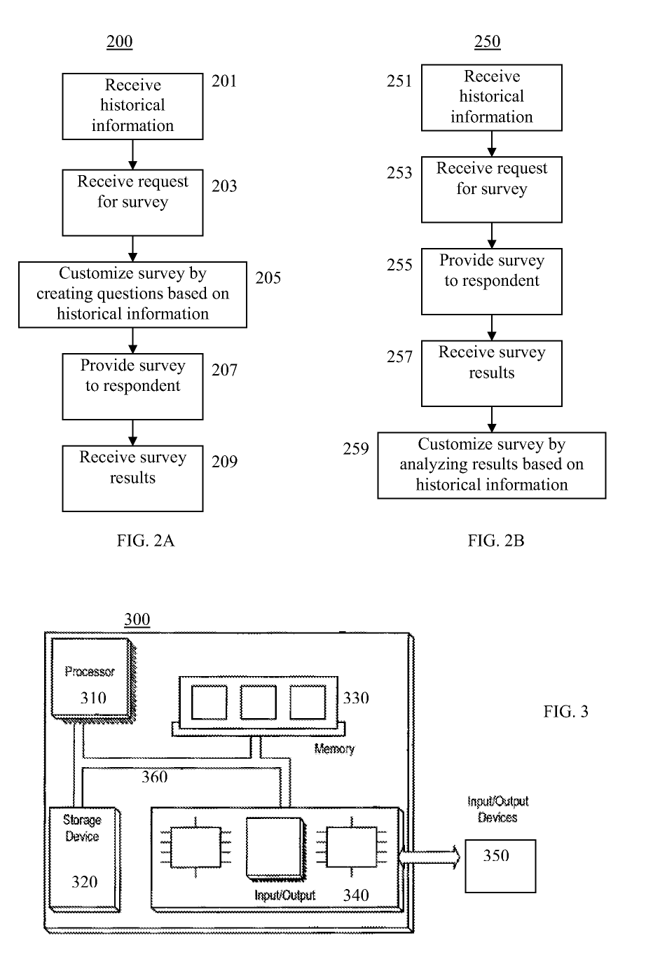

The survey system 160 is configured to obtain survey response information from potential customers 103 and 105, and to make the survey response information available to the advertiser 110, the advertisement delivery platform 130, and/or the attribution system 150, or to another component of the system 100. For example, with reference to FIG. 2A, the survey system 160 performs a process 200 for customizing surveys, in which the survey system 160 receives historical information regarding activity of a potential customer from the historical information repository 145 (201). The historical information includes browsing history information and advertisement delivery history information. The survey system 160 also receives a survey request (203). The survey request may be, for example, an indication that a predetermined action was taken involving a potential customer, or a request for a survey to be sent to the potential customer in response to completion of the predetermined action. For example, when a potential customer completes a purchase process or an account creation process, the consumer terminal 103 associated with the potential customer can transmit a survey request to the survey system 160. The survey request can include information regarding the purchase or account creation process, information regarding the advertiser 110, and/or information regarding the potential customer.

In response to the request, the survey system 160 creates a customized survey for the potential customer based on historical information (205). In some implementations, the survey system 160 can create the customized survey by retrieving a survey form from a survey form repository 165 based on information included in the request, such as information that identifies an advertiser whose goods and/or services were purchased, and by populating the form with customized questions that include and/or are based on the historical information specific to the potential customer. For example, when a potential customer completes a purchase, the survey system 160 populates a survey form with a question regarding the potential customer's perception of a causal relationship between viewing various advertisements that were delivered to the potential customer and the decision to make the purchase. Additionally, the survey system 160 can create customized survey questions that are verifiable based on the historical information. For example, the survey system 160 can populate a survey form with a question regarding whether the potential customer received a particular advertisement, where the historical information indicates that the advertisement was delivered to the potential customer.

When the creation of the customized survey is completed, or at least as questions are generated, the survey is provided to the potential customer (207). After completion by the potential customer of one or more survey questions, the survey response information, such as answers or responses to the survey questions, is received by the survey system 160 (209). The survey response information can be stored for subsequent use and/or can be retransmitted to another component of the system 100, such as the attribution system 150. Alternatively, the survey response information can be sent directly to another component of the system 100, such that the survey results are initially received by the other component, such as the attribution system 150. In some implementations, the survey response information can be used by the survey system 160 to create and transmit additional survey questions, such as follow-up questions, or questions that are designed to elicit additional information regarding previously-received response information.

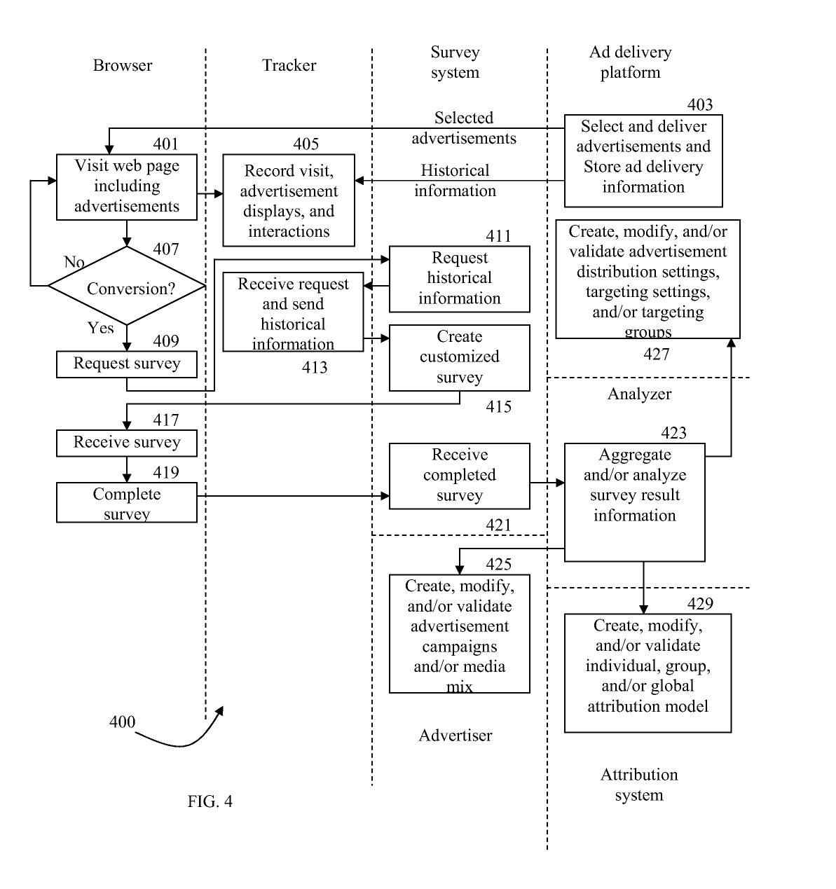

One or more of the components of the system 100, such as the consumer terminals 103 and 105, the advertisement delivery platform 130, the tracker 140, the attribution system 150, the survey system 160, and/or the analyzer 170 can include one or more computer systems, such as the computer system 300 of FIG. 3. The computer system 300 includes a processor 310, memory modules 330, a storage device 320, and an input-output module 340 connected by a system bus 360. The input-output module 340 is operable with one or more input and/or output devices 350, including a communication device for operable connection with the network 190 and with the other components of the system 100. The one or more computer systems 300 can perform the various functions of the components of the system 100 by executing computer-readable instructions, such as computer software stored on a computer-readable storage device.

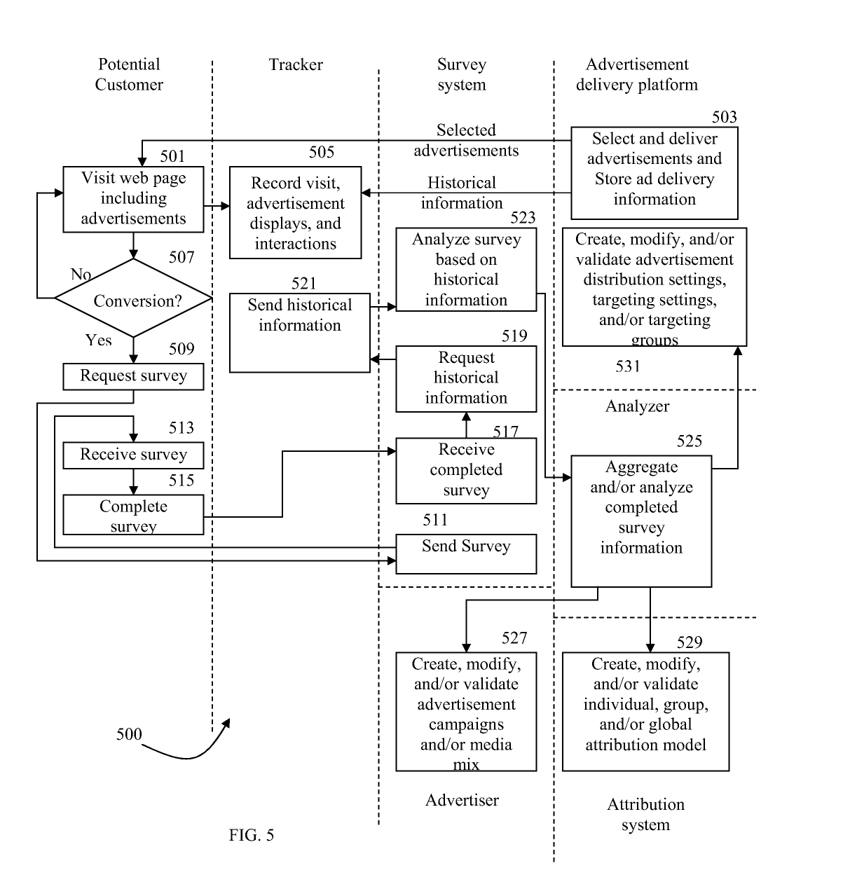

In one example implementation of the process 200, as illustrated by the process 400 in FIG. 4, the potential customer visits a web page that includes one or more advertisements using a browser application 107 of the consumer terminal 103 (401). Based on visiting the web page, the advertisement delivery platform 130 selects and delivers an advertisement to the potential customer for display and transmits historical information regarding the visit and regarding the advertisement selection is transmitted to the tracker 140 by the advertisement delivery platform 130 (403). Additionally, the consumer terminal 103 and/or a server computer that hosts the web page can also transmit historical information regarding the visit to the tracker 140. The tracker 140 receives and stores the historical information (405), and can associate the stored historical information with one or more of the publisher 120, the visited web site, the potential customer, the consumer terminal 103, the advertiser 110, and/or the selected advertisement. An indication of any interaction with the selected advertisement, such as clicking on the advertisement, is also sent to the tracker 140 and recorded. As the potential customer interacts with the web page, a determination is made regarding whether the potential customer has completed a selected action, such as purchasing a product (407). If the selected action has not been completed, and the potential customer continues browsing, the browser activity and the advertisement delivery platform activity are recorded by the tracker 140.

If, however, the selected action is completed, the browser application 107 automatically requests a survey (409) from the survey system 160. As discussed above with respect to FIG. 2A, when the survey system 160 receives the request for the survey, the survey system 160 can request historical information associated with the potential customer, the consumer terminal 103, the browser application 107, and/or the advertisement selections from the tracker 140 (411). When the tracker 140 receives the request for information, the tracker 140 retrieves the requested information from the historical information repository 145, and transmits the historical information to the survey system 160 (413). After receiving the historical information, the survey system 160 creates a customized survey (415) and transmits the customized survey to the potential customer for completion. For example, the survey can be provided to the potential customer via the browser application 107. After receiving the customized survey (417), the potential customer then completes the survey (419) and transmits survey response information to the survey system 160.

As mentioned above, the survey system 160 can create the customized survey by accessing a survey form from the survey form repository 165 based on an identity of the advertiser 110 with whom the potential customer completed the selected action. Additionally, multiple survey forms in the survey form repository 165 can be associated with an advertiser 110, and the survey system 160 can select a survey form from among the survey forms associated with the advertiser 110 at random, based on information about the potential customer, based on information about the selected action, and/or based on information about the advertisements delivered to the potential customer. The survey forms include instructions or information regarding formulation of survey questions, including question text and/or question format.

For example, a survey form may indicate that a first question is a ranking question and includes the phrase “Rank the following advertisements according to influence on your purchase, where the first advertisement was most influential.” A second question could ask the potential customer to rate the influence of specific advertisements that were displayed to the potential customer, or with which the potential customer interacted. A third question could ask whether the potential customer saw one or more advertisements shown in the survey question. Other questions can relate to the perceived causal contribution of various advertisements and/or various advertisement channels to the potential customer's action. The questions can also relate to an effect of an amount of time between the advertisement delivery and the potential customer's action, and/or a perceived causal contribution of non-advertising sources, such as referrals from friends or news reports about the goods or services or about the advertiser 110.

The survey system 160 can then populate the form with information regarding the advertisements of the advertiser 110 based on the historical information. For example, instructions associated with the survey form can cause the survey system 160 to identify the four most recent advertisements displayed to the potential customer, and to add an image of each identified advertisement to a field of the survey associated with the first question for ranking by the potential customer. Thus, the customized survey is designed to elicit subjective survey response information regarding selected aspects of the potential customer's use of the system 100.

When the survey system 160 receives the survey response information (421), the survey system 160 transmits the survey response information, information regarding the customized survey, and/or historical information to an analyzer 170. The analyzer 170 can analyze the survey response information to create analysis information and/or the analyzer 170 can aggregate the survey response information and/or the analysis information (423). For example, the analyzer 170 can analyze each survey question response to determine whether the responses provided by the potential customer are inconsistent with the historical information, such as by identifying where a potential customer indicated that they did not see an advertisement that the historical information indicates was, in fact, delivered to the potential customer. This kind of comparison of the survey response information with the historical information can be used as, or used to create, an indication of accuracy and/or reliability of the survey results. The survey accuracy or reliability information can be used as a basis to completely ignore the survey results or to modify how the results are used, such as by discounting the results by applying a lower weighting factor than is applied to more accurate or reliable survey results.

In addition to comparing the survey response information with the historical information, the analyzer 170 can perform other analyses to determine the analysis information. For example, the analyzer 170 may determine which advertisement was identified by the potential customer as the most influential regarding the decision to complete the selected action. The analyzer 170 may also note historical information corresponding to the identified advertisement, such as a time of delivery of the advertisement relative to the time of completion of the selected action, or the address of the web page on which the identified advertisement was displayed. Additionally, the analyzer 170 can aggregate the survey response information to generate statistical information. For example, the analyzer 170 may determine from survey response information from multiple surveys that a certain category of advertisements is most often indicated by potential customers as being the most influential, such as display advertisements which are located on web pages visited by potential customers after clicking on a search result link included in a list of search results. In another example, the category of most influential advertisements could be the advertisements delivered most closely in time before the completion of the selected action, or those delivered in a window of time before completion of the selected action, such as during the preceding day and not within 6 hours of the time of completion of the selected action.

After analyzing and/or aggregating the survey response information, the analyzer 170 distributes selected analysis information to the advertiser 110, the advertisement delivery platform 130, and/or the attribution system 150, among others, for subsequent use by the receiving party. For example, when the advertiser 110 receives the analysis information, the advertiser 110 can create, modify, and/or validate advertisement campaign settings and/or media mix decisions (425). Referring to the example above, based on the selected analysis information, such as analysis information indicating that display advertisements are statistically the most influential in potential customer's decisions to purchase a product, the advertiser 110 can decide to increase the budgets associated with display advertisements that fall into the category of most influential advertisements. If the advertiser 110 maintains a fixed budget for the campaign, or for all media costs, the increase in the budgets for advertisements that fall into the category of most influential advertisements may be offset by decreases in budgets for other display advertisement campaigns, for other types of advertisement campaigns, such as paid search campaigns, or both. Thus, the advertiser can optimize the effectiveness of a fixed media budget by adjusting one or more aspects of the budget based on the analysis information received from the analyzer 170. Optionally, this type of analysis information can additionally, or alternatively, be send to an advertisement management system that can then provide recommendations to the advertiser regarding media budget adjustments, or automatically make such adjustments.

Similarly, based on selected analysis information, the advertisement delivery platform 130 can create, modify, and/or validate distribution settings, targeting settings, and/or targeting groups (427) in order to improve the effectiveness of the advertisement selections that it makes when deciding which advertisement from among many candidate advertisements to send to a given potential customer. The distribution settings, targeting settings, and/or targeting groups can be those for the potential customer, those for a group including the potential customer, and/or those used for all selections. Additionally, the attribution system 150, the advertiser 110, or both, can use the analysis information to create, modify, and/or validate an attribution model that determines assignment of attribution credit among various advertisements delivered to a potential customer that has completed the selected action, or among various publishers who control web pages or other locations through which the advertisements are delivered to the potential customer (429).

In some implementations, as illustrated in FIG. 2B, the survey system 160 is configured to obtain survey response information from potential customers by performing a process 250 for customizing surveys, in which the survey system 160 receives historical information regarding activity of the potential customer from the historical information repository 145 (251). The survey system 160 also receives a survey request in response to completion of the selected action (253). Based on the request, the survey system 160 provides a survey associated with the advertiser 110 to the potential customer (255). After the survey is completed by the potential customer, or as the survey is completed, the survey response information is transmitted to the survey system 160 (257). The survey system 160 can then customize the survey by retrieving the historical information specific to the potential customer and by analyzing the survey response information based on the historical information (259). For example, when a potential customer completes a purchase, the survey system 160 provides a generic survey form to the potential customer for completion. The generic survey may include a question that asks the potential customer to describe the advertisement that contributed most to their decision to purchase a product. The response can then be analyzed by comparison of the described advertisement to the advertisements that were delivered to the potential customer 103 by referring to the historical information to customize the survey information. When the survey response information is customized, or at least as survey response information is customized, the survey response information can be provided to selected components of the system 100 for use, such as described above.

Referring to FIG. 5, a process 500 provides one example of implementation of the process 250. Initially, the potential customer visits a web page using a browser application (501). Based on the potential customer's visit of the web page, the advertisement delivery platform 130 selects and delivers an advertisement to the potential customer for display (503). Additionally, historical information regarding the visit and historical information regarding the advertisement selection are transmitted to the tracker 140, and the tracker 140 stores the historical information (505). Any interaction with the selected advertisement, such as clicking on the advertisement, is also sent to the tracker 140 and recorded. As the potential customer interacts with the web page, a determination is made regarding whether the potential customer 103 has completed a selected action (507), such as purchasing a product. If the selected action has not been completed, and the potential customer continues browsing, the browser activity and the advertisement delivery platform activity are recorded.

If, however, the selected action is completed, the browser program automatically requests a survey (509) from the survey system 160. As discussed above with respect to FIG. 2B, when the survey system 160 receives the request for the survey, the survey system 160 transmits a survey associated with the advertiser to the browser program (511). When the browser program receives the survey (513), the potential customer then completes the survey (515) and transmits survey response information to the survey system 160. Before or after the survey system 160 receives the survey response information (517), the survey system 160 requests historical information from the tracker 140 associated with the potential customer (519). In response to receiving the request for historical information from the survey system 160, the tracker 140 transmits historical information associated with the potential customer to the survey system 160 (521).

When the survey system 160 has received the historical information and the survey response information, the survey system 160 analyzes the survey response information based on the historical information (523) in order to customize the survey response information. For example, the survey system 160 can compare the survey response information and the historical information, such as by determining that an advertisement indicated in the survey response information as being viewed before and contributing to the completion of the selected action was, in fact, delivered to the potential customer before the selected action was completed. Additionally, where the survey delivered to the potential customer is generic, the survey system 160 can determine whether other survey response information is accurate, such as survey response information indicating a certain product that was purchased by the potential customer.

When the survey system 160 completes the analysis, the survey system 160 transmits the customized survey response information and/or historical information to an analyzer 170. The analyzer 170 can analyze the survey response information to obtain analysis information, and/or the analyzer 170 can aggregate the survey response information and/or the analysis information (525). For example, the analyzer 170 can analyze and/or aggregate the customized survey response information as described above. After analyzing and/or aggregating the survey response information, the analyzer 170 distributes selected analysis information to the advertiser 110, the advertisement delivery platform 130, and/or the attribution system 150, among other components, for subsequent use by the receiving component. For example, the advertiser 110 can create, modify, and/or validate advertisement campaign settings and/or a media mix (527). The attribution system 150 can create, modify, and/or validate an attribution model for the individual potential customer, an attribution model for a group including the potential customer, or a global attribution model (5297). The advertisement delivery platform can create, modify, and/or validate settings for advertisement selection and distribution for the potential customer, a group including the potential customer, or global settings (531).

While some implementations are described above, these should not be viewed as exhaustive or limiting, but rather should be viewed as exemplary, and included to provide descriptions of various features. It will be understood that various modifications may be made without departing from the spirit and scope of the invention. For example, the system 100 can be a non-commercial system for content distribution. However, in many or all implementations, the system can include some or all of the components and/or functionality described herein. Alternatively, the functions described above can be performed by other components, including two or more different components, and in other contexts.

Furthermore, it should be noted that actions described or recited in the claims can be performed in a different order and by different actors. Certain features that are described in this specification in the context of separate embodiments can, in some implementations, be implemented in combination in a single implementation. Conversely, various features that are described in the context of a single embodiment can, in some implementations, be implemented separately, or in any suitable sub-combination.

Similarly, while operations are depicted in the drawings in a particular order and/or in association with a particular system component or user, this should not be understood as requiring that such operations be performed in the particular order shown or in sequential order, or that all illustrated operations must be performed, or must be performed by the associated component or user, to achieve desirable results. Moreover, the separation of various system components in the embodiments described above should not be understood as requiring such separation in all embodiments.

As an example, while customized surveys relating to advertisement delivery and assignment of causal attribution are discussed above, other types of surveys can be customized, such as political or educational surveys.

Accordingly, other implementations are within the scope of the following claims.

1. A computer-implemented method for conducting a survey, the method comprising:
receiving, by one or more processors of a survey computer system, historical information relating to activity involving a user of an affiliated system;
providing a survey to the user in response to a selected action involving the user within the affiliated system;
receiving, by one or more processors of the survey computer system, survey information in response to the survey; and
customizing, by one or more processors of the survey computer system, the survey for the user based on the historical information.

2. The method of claim 1, wherein customizing the survey comprises creating a question of the survey based on the historical information.

3. The method of claim 1, wherein customizing the survey comprises adjusting an analysis of the survey information based on the historical information.

4. The method of claim 1, wherein the historical information includes information regarding at least one advertisement delivered to the user.

5. The method of claim 4, wherein customizing the survey comprises creating a question regarding the user's perception of a causal contribution of the at least one advertisement to the selected action involving the user.

6. The method of claim 5, further comprising analyzing the survey information, and, based at least in part on analyzing the survey information, at least one of creating, modifying, and validating an attribution model, the attribution model being for determining an apportionment of causal contribution among advertisements that were delivered to the user prior to the selected action.

7. A system for conducting a survey, the system comprising:
a receiver that receives historical information relating to activity involving a user of an affiliated system and that receives survey information from the user, the survey information being based on a survey provided to the user in response to a selected action involving the user within the affiliated system;
a transmitter that provides the survey to the user in response to the selected action involving the user within the affiliated system; and
at least one processor programmed to customize the survey in response to the selected action involving the user within the affiliated system, the at least one processor customizing the survey based, at least in part, on the historical information.

8. The system of claim 7, wherein the processor is programmed to customize the survey by creating a survey question based on the historical information.

9. The system of claim 7, wherein the processor is programmed to customize the survey by adjusting an analysis of the survey information based on the historical information.

10. The system of claim 7, wherein the historical information includes information regarding at least one advertisement delivered to the user.

11. The system of claim 10, wherein the processor is programmed to customize the survey by creating a question regarding the user's perception of a causal contribution of the at least one advertisement delivered to the user to the selected action involving the user.

12. The system of claim 11, wherein the processor is programmed to perform at least one of aggregating and analyzing the survey information, and, to perform at least one of creating, modifying, and validating an attribution model based on at least one of the aggregation and the analysis, and wherein the attribution model is for determining an apportionment of causal contribution to the at least one advertisement that was delivered to the user prior to the selected action.

13. A computer-implemented method for advertising, the method comprising:
receiving, by at least one processor of an attribution computer system, survey information relating to at least one customized survey of a user, the survey information including information based on historical information regarding activity of an affiliated system that involves the user;
performing, by at least one processor of the computer system, at least one of creating, modifying, and validating an attribution model, the attribution model for determining an apportionment of causal contribution to the at least one advertisement that was delivered to the user prior to a selected action; and
apportioning attribution credit to the at least one advertisement based on the attribution model.

14. The method of claim 13, wherein at least one processor of the attribution computer system performs at least one of creating and modifying the attribution model based on an aggregation of survey information related to customized surveys of users, each customized survey being based on historical information regarding activity of the affiliated system that involves an associated user of the affiliated system.

15. The method of claim 13, wherein at least one processor of the computer system performs at least one of creating and modifying the attribution model based on survey information associated only with the user, and the method further comprises associating the attribution model only with the user as a user-specific attribution model.

16. The method of claim 13, wherein at least one processor of the computer system performs at least one of creating and modifying the attribution model based on survey information associated only with one or more users of a predetermined group of users of the affiliated system, and the method further comprises associating the attribution model only with the users of the predetermined group.

17. A computer-implemented method for advertising, the method comprising:
receiving, by an one or more processors of an advertisement distribution computer system, survey information relating to at least one customized survey of a user, the survey information including information based on historical information regarding activity involving the user on an affiliated system;
performing, by one or more processors of the advertisement distribution computer system, at least one of creating, modifying, and validating a distribution setting, the distribution setting determining, at least in part, how the advertisement distribution computer system selects advertisements for distribution; and
distributing advertisements based on selections made by the advertisement distribution computer system according to the distribution setting.

18. The method of claim 17, wherein the distribution setting relates to a group membership of the user, and wherein distributing includes determining that the user belongs to the group, and selecting an advertisement associated with the group.

19. The method of claim 17, wherein the distribution setting relates to targeting information associated with the user, and wherein distributing includes comparing the targeting information associated with the user with targeting information associated with candidate advertisements, and selecting an advertisement based on the comparison.

20. A computer-implemented method of advertising, the method comprising:
receiving, by one or more processors of an advertisement campaign management computer system, survey information relating to at least one customized survey of a user, the survey information including information based on historical information regarding activity involving the user on an affiliated system;
performing, by one or more processors of the advertisement campaign management computer system, at least one of creating, modifying, and validating a campaign setting, the campaign setting being for determining, at least in part, how an advertisement associated with the campaign is delivered; and
distributing advertisements according to the campaign setting.
